(19) United States
(12) Patent Application Publication
(10) Pub. No.: US 2025/0054014 A1
(43) Pub. Date: Feb. 13, 2025

(54) METHOD AND SYSTEM FOR PREDICTING AND OPTIMIZING VARIABLE REWARDS FOR USER ACHIEVEMENT OF GOALS

(71) Applicant: Sameer Gupta, Las Vegas, NV (US)

(72) Inventor: Sameer Gupta, Las Vegas, NV (US)

(21) Appl. No.: 18/232,250

(22) Filed: Aug. 9, 2023

(51) Int. Cl. G06Q 30/0208; A63B 24/00; G06Q 10/0639

(52) U.S. Cl. CPC G06Q 30/0208; A63B 24/0003; G06Q 10/0639

(57) ABSTRACT

A rewards platform is configured to receive information regarding activities of a user and generate rewards for the user's activities meeting one or more goals. When the platform detects that the user activity information meets at least one goal, a rewards generator generates and outputs a reward which comprises either a randomly generated award or an optimized reward, where the optimized reward has characteristic which change based upon user activity feedback. The randomized rewards introduce volatility into the reward process.

### FIELD OF THE INVENTION

The present invention relates to methods and systems which provide rewards for user behaviors.

### BACKGROUND OF THE INVENTION

The concept of providing a reward as an incentive for a person to engage in a behavior, is well known. For example, stores often implement rewards programs which offer their customers rewards for making certain purchases, purchasing certain quantities of goods, etc. Businesses may offer employees rewards for meeting sales goals or quotas. Parents may offer rewards to their children for scholastic achievements.

Various problems exist with current methodologies and system for awarding rewards. One problem is the time and energy necessary to track user performance. For example, a company might offer its sale employees a bonus for meeting certain sale quotas. This may require the sales division of the company to track the sales of each employee during a period of time to determine compliance. At the same time, the same company might offer its delivery drivers a different reward for the number of products delivered in a period of time. This may require the shipping division of the company to separately track that information.

Another problem is that simple rewards structures often prove ineffective over time. For example, a company that offers a certain bonus for sales personnel reaching a certain level of sales may find that the sale personnel reach the target level but then do not sell more. Alternatively, the company may seek to raise the sale quota necessary to reach the reward and then find that the sales personnel do not comply.

An improved method and system for awarding rewards that addressing these and other problems is desired.

### SUMMARY OF THE INVENTION

Embodiments of the invention comprise a method and system for providing variable rewards for user achievement of one or more goals.

In one embodiment, a variable rewards system comprises a rewards platform comprising at least one server and a data storage device, the server comprising a communication interface, a processor, a memory and machine readable code stored in the memory and executable by the processor to cause said server to store, in a database associated with the data storage device, at least one activity goal associated with a user, the activity goal comprising activity criteria; implement a tracking engine, the tracking engine configured to receive user activity information regarding the user, determine if the activity information meets said activity criteria for the at least one activity goal, and when the activity information meets the activity criteria, output a reward trigger; implement a reward randomizer which is configured to output a randomly generated reward; implement a reward optimizer which is configured to output an optimized reward, the optimized reward comprising at least one reward which varies based upon changes in the activity information; and implement a rewards engine configured to select, in response to the reward trigger, either the randomly generated award or the optimized reward, wherein the selection of the randomly generated award has at least one first frequency and the selection of the optimized reward has at least one second frequency, and transmit an indication of the selected reward to the user.

The activity information may comprise, for example, exercise activity information, work productivity information, purchase information or other information relating to the activity of one or more users.

The randomly generated award may be selected using a random number generator, such as relative to a table of potential rewards. The optimized rewards are preferably awards which vary by type, frequency or amount, so as to cause future activities by the user to achieve at least one of the goals. In one configuration, at least one award comprises “no reward.” At least one of the randomly generated awards and the optimized rewards preferably vary, so as to introduce variability or volatility into the rewards.

Further objects, features, and advantages of the present invention over the prior art will become apparent from the detailed description of the drawings which follows, when considered with the attached figures.

### DESCRIPTION OF THE DRAWINGS

FIG. 1 illustrates a rewards system in accordance with one embodiment of the invention;

FIG. 2 schematically illustrates aspects of a rewards platform in accordance with an embodiment of the invention; and

FIG. 3 is a flow diagram of a method of implementing one or more rewards in accordance with an embodiment of the invention.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

Aspects of the invention comprise systems, methods and devices for providing variable rewards for user achievement of one or more goals. In certain aspects of the invention, the invention is configured to track user activity for achievement of one or more goals, and to implement a system of variable rewards for achievements of goals, where reward variability is selected to optimize user achievement of goals. In one aspect of the invention, behavior feedback in response to awarded rewards is utilized by the system and method to optimize future rewards.

The invention has applicability to a wide variety of environments. As detailed below, for example, the invention may be utilized to provide variable rewards for the achievement of individual goals or goals of a company or group. For example, the invention may be utilized to provide variable rewards for the achievement of an individual's own fitness goals, for the achievement by an employee of a employer's work goals, and to provide rewards for groups of users, such as members of a club, multiple employees of an employer or the like.

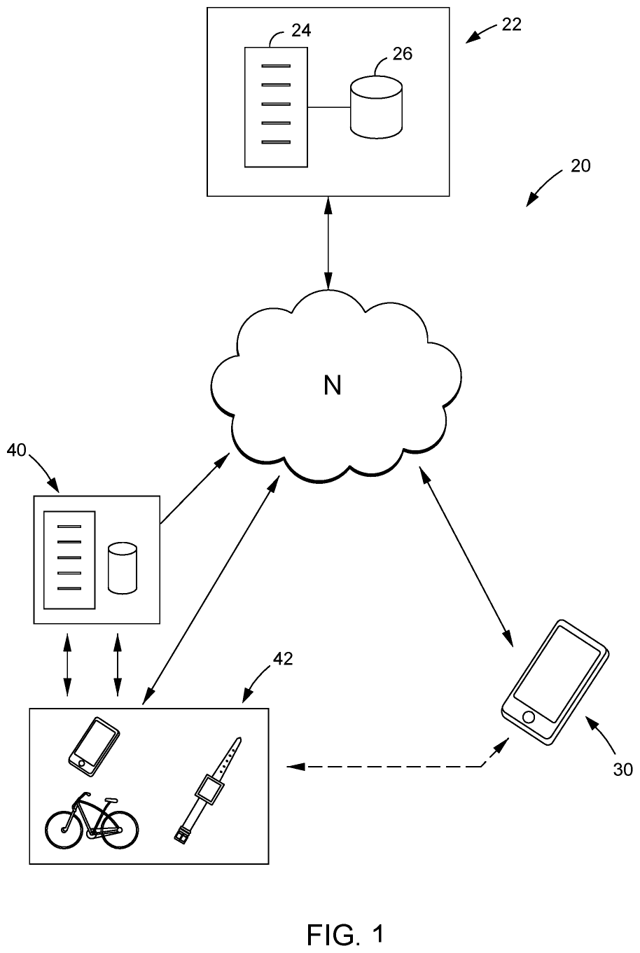

FIG. 1 illustrates one embodiment of a rewards system 20 of the invention. As can be seen, the system 20 may comprise a rewards platform 22. The rewards platform 22 may comprise one or more devices, such as a collection of linked devices. As one example, the rewards platform 22 may comprise a server 24 capable of receiving user activity information, processing that information and generating rewards information.

The server 24 may store information (for example, as detailed below, user activity information, goal information and reward information), such as in at least one data storage device 26 (such as RAM, ROM, EPROM, hard drive, flash drive, optical media and associated reader, etc.). In addition, the data storage device 26 need not be part of the server 24 but may be data storage that is remotely accessible to the server.

The server 24 preferably comprises a computing-type device. For example, the server 24 may comprise one or more processors, at least one communication device or interface, and may include one or more additional memory or data storage devices (such as separate from the database(s) 26). In one or more embodiments, the processor(s) is configured to execute one or more instructions, such as in the form of machine readable code (i.e. “software”), to allow the server 24 to perform the functions herein. The software is preferably non-transitory, such as by being fixed in a tangible medium. For example, the software may be stored in the one or more memory devices (RAM, ROM, EPROM, hard drive, etc.). One or more of the memory devices may be read-only. In addition, the software may be stored on a removable medium in some embodiments. In general, the one or more memory devices are used as temporary storage or may be used for permanent or near permanent storage (e.g. storage for long periods of time). For example, the one or more memory devices may be random access memory or cache memory used to temporarily store some information and/or instructions for execution by the at least one processor.

The software may comprise one or more modules or blocks of machine readable code. Each module may be configured to implement particular functionality when executed by the one or more processors, and the various modules may work together to provide overall integrated functionality. Of course, in certain embodiments, it is also possible for various of the functionality to be implemented as hardware, i.e. a processor or chip which is particularly designed to implement various of the functionality described herein.

In one embodiment, the server 24 may include one or more input and/or output devices. As one example, an operator of the rewards platform 22 might interface with the server 24 via a workstation or other device. Such a workstation or the like might comprise a keyboard, mouse, touchscreen, video display or the like, whereby the processor of the server 24 may receive information from an operator and/or output information thereto. This allows, for example, an operator of the server 24 to interface with the server 24 to upgrade, maintain, monitor, etc., the server or other aspects of the platform.

In one embodiment, the processor and other elements of the server 24 may be linked and thus communicate over one or more communication buses. In this manner, for example, the processor may read/receive software from the memory for execution, receive inputs and provide outputs to the various I/O devices, receive information from or output information to the communication interface, etc.

The communication devices or interfaces permit the server 24 to communicate with external devices, networks, systems and the like. As one example, as illustrated in FIG. 1, the server 24 may communicate with one or more user devices 30. The user devices 30 may comprise mobile computing or communication devices. For example, the user devices 30 may comprise a tablet such as an iPad®, a telephone, a PDA, an Apple® watch or the like. Preferably, the user devices 30 are capable of receiving user input, transmitting data and receiving data (such as via a communication interface), and displaying information or data, such as via a video display.

A user device 30 may be in various locations. For example, a user device 30 might be carried by a user and thus move from location to location. A user device 30 might also be located in a fixed location, such as an office building, home, apartment or the like.

The communication interface of the server 24 may permit data to be exchanged between the server 24 and the user devices 30 (e.g. sent from the server to the user devices or sent from the user devices to the server) via one or more communication paths or links (which paths may include one or more networks N, including WANs, LANS, public or private networks, the Internet, cellular telephone networks or the like). The server 24 and the user devices 30 may be capable of utilizing various communication protocols, such as 3G, 4G, 5G, TCP/IP, to communicate with a wide variety of other devices, and may communicate over wired and/or wireless links.

In one embodiment, each user device 30 also includes at least one processor and at least one memory device which stores software for execution by the at least one processor for implementing aspects of the invention, one or more communication interfaces and one or more I/O devices (such as video display, keypad or touchscreen, etc., as is known in the art relative to desktop and laptop computers, tablets, PDAs, etc.). In the case where a user's device 30 is a mobile communications device, the software may be in the form of an “application” or software application which the user downloads and installs on their device (such as by storing in it the memory). In a preferred embodiment, execution of the software at the server 24 and at the user device 30 causes the processors thereof to implement communications comprising the exchange of information or data between the devices, such as in the manner described below.

In other embodiments, a user's device 30 may implement a web browser and the rewards platform 22 may include or support a website, such as implemented by a webserver which is implemented by the server 24 or a separate server. The website may cause the web browser of a user's device 30 to present particular information, receive information and the like. Alternatively, as detailed below, the user's device 30 might store and execute an application which interfaces to the server 24 and facilitates the presentation of information to the user and other features, such as described in more detail below.

As illustrated in FIG. 1, the rewards system 22, such as the server 24, may communicate with one or more activity platforms 40. The activity platforms 40 may comprise computing devices, systems or platforms which receive, generate, store and/or process user activity information, such as received from one or more user activity devices 42. The user activity devices 42 might comprise the user communication devices 30 but might comprise other types of devices.

### As Non-Limiting Examples:

A) The activity platform 40 might comprise the Zwift™ virtual cycling and running platform and the user activity device might comprise a user's smart cycling training or smart treadmill;
B) The activity platform 40 might comprise the Apple™ Fitness™ platform and the user activity device might comprise an Apple™ iPhone™ or watch;
C) The activity platform 40 might comprise the Jira™ software development tool and the user activity device might comprise a computer;
D) The activity platform 40 might comprise a casino loyalty system and the user activity device might comprise a gaming machine;
E) The activity platform 40 might comprise a vehicle tracking system and the user activity device might comprise a vehicle.

In this regard, the activity platforms 40 and user activity devices 42 may comprise a wide range of devices and systems which are capable of providing information (raw or processed) regarding the activities of one or more users.

In one embodiment, the rewards system 20 may be configured implement various functionality, including but not limited to generating, at one or more times, a reward. In one configuration, rewards are variable, meaning that they may be different or vary, such as for achievement of the same goal or different goals, such as at different times. Further, as detailed below, the rewards are also preferably optimized.

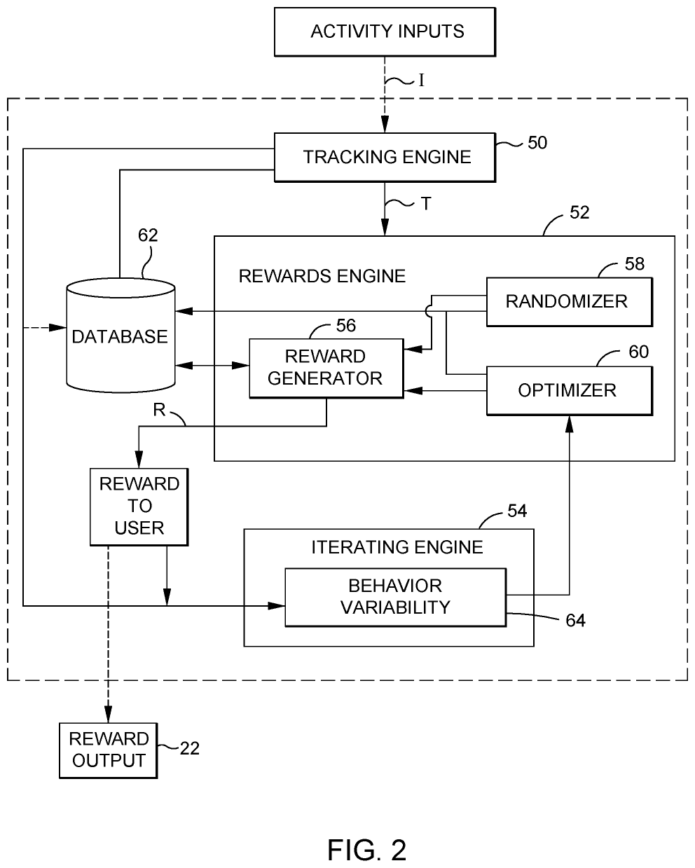

As indicated above, various of the functionality of the invention may be implemented via software which is executed by a processor of the server 24 and/or processor of the user device 30. Referring to FIG. 2, in one embodiment, the rewards platform 22 is configured to implement a tracking engine 50, a rewards engine 52 and an iterating engine 54. The features and functions of these engines will be described in more detail below. In one configuration, these engines might be implemented as software modules running on the server 24. In other embodiments, they might be implemented by different devices which are in communication with one another.

In general, the tracking engine 50 may be configured to receive and process user activity inputs I, to determine if one or more user achievements have occurred. If so, the tracking engine 50 may output a notification trigger T to the rewards engine 52. The rewards engine 52 may implement a rewards generator 56 to generate one or more rewards R, such as based upon information from a randomizer 58 and an optimizer 60. The rewards generator 56 may utilize information stored in a database 62 (such as stored by the data storage device 26 of the rewards platform 22) to generate the rewards R, and may store information regarding generated rewards in that or another database.

In one configuration, activity information and rewards information may be provided to the iterating engine 54, such as to a behavior variability element 64 thereof. The behavior variability element 64 is preferably configured to monitor user performance over time, such as in response to awarded rewards and generate an output which is utilized by the optimizer 60 to optimize future awarded rewards. In one configuration, the iterating engine 54 and optimizer 60 attempt to predict rewards which are likely to result in future achievement of goals.

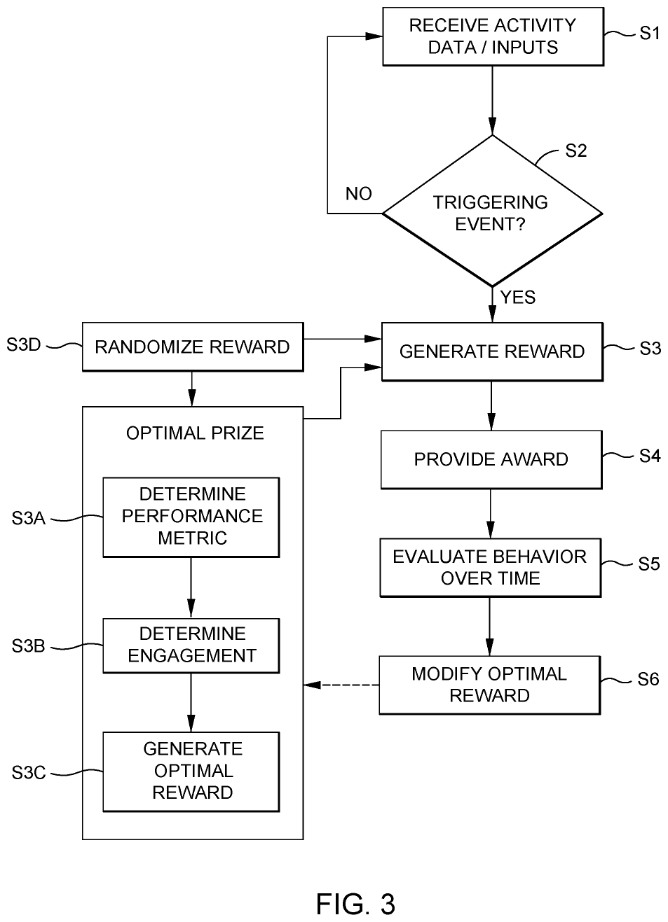

Aspects of methods of generating variable rewards and operation of the system described above, will be described with reference to FIG. 3.

In one example, the rewards engine 22 receives one or more user activity inputs, as at step S1 of FIG. 3. Referring to FIGS. 1 and 2, those inputs might be received, for example, from an activity platform 40 or a user device 42. The activity inputs might comprise, for example, information regarding work output, sales, medication compliance, fitness activities, purchases, games played, or any other number of activities that one or more users may engage in. As illustrated in FIG. 2, the activity inputs may be provided to the tracking engine 50 of the rewards platform 22.

In one embodiment, the activity information may be stored, such as in a database 62 which is associated with the data storage device 26. The activity information may be stored in many forms. In one embodiment, the activity information may be stored in relation to one or more users.

In a step S2, the one or more user activity inputs may be evaluated for a triggering event. A triggering event may comprise, for example, the one or more activity inputs meeting a goal (or other achievement). The goal or other achievement criteria might be defined by a user (e.g. such as based upon input of the user) or might be defined by a third party or the like. The goal or achievement criteria may be defined by data which is stored in the database 26, such as in relation to one or more users.

As one example, a particular user may set up a user account. Data which defines one or more goals or achievement criteria may be stored in association with the user's account. As one example, if the user is a runner, the user might set a goal of running 1 mile in under 6 minutes. However, the user might define a plurality of goals or achievement criteria. For example, if the user is a runner who runs a particular route, the user might set a goal for running that route a particular number of times in a time period, such as at least 5 times in 1 week. The user might also set another goal of running at least 30 miles in a week. Of course, the number of goals or achievements may vary and may relate to any number of activities.

In other examples, achievements or goals might be defined for one or more members of a group (whether work, social or otherwise) or club, etc., and the tracking engine 50 may compare the activity information of each user and/or of multiple users, of the group or club to the achievements or goals therefor. For example, a user may belong to a running club and the club may set a goal for each member to run at least 5 miles in a week. A triggering event may be determined for each member of the group who runs the minimum 5 miles. As another example, the running group might set a group target of running 1000 miles in 1 week. A triggering event may then be determined for all of the members of the group if their collective activity inputs indicate that they met the 1000 mile goal.

As one aspect of the invention, the tracking engine 50 uses the activity information and compares it to the stored data which defines the one or more goals, to determine if such are met. As indicated, this comparison may be relative to individual activity inputs, or combined activity inputs relating to an individual user or multiple users.

If a triggering event is not determined, then the tracking engine 50 may continue to receive and evaluate new activity inputs. If a triggering event is determined, then the tracking engine 50 may output a trigger T. The trigger T may include information regarding the achievement of a particular goal of a user, group of users, etc.

In a step S3, in the event a goal or achievement has been met as to at least one user, a reward may be generated. In one embodiment, the rewards generator 56 generates a reward for the one or more users. In one configuration, the rewards generator 56 generates rewards which are variable and which are optimized to predict future behavioral compliance. In this regard, in one configuration, the rewards generator 56 selects an award based upon a combination of random chance and reward optimization.

As illustrated in FIG. 2, the optimizer 60 may be configured to generate and output one or more rewards, such as for selection by the rewards generator 56. As illustrated in FIG. 3 and described in more detail, the optimizer 60 may be configured to generate its output based upon one or more of user responses (e.g. behavioral responses to past rewards) and past rewards, including in relation to the timing and/or sequence thereof. Preferably, the optimizer 60 utilizes this information to predict one or more rewards which are likely to maximize the user's behavior towards one or more of the goals/achievements.

In one configuration, as illustrated in FIG. 3, in a step S3A, the optimizer 60 may determine a performance metric. The performance metric may be configured to reflect activity compliance to goals/achievements in relation to expected compliance, such as by evaluating the user activity over a period of time in relation to a baseline.

In a step S3B, user engagement may then be determined using the performance metric. In one configuration, engagement is determined as a relationship of the performance metric in combination with the user activity inputs (from the tracking engine 50). The user engagement is preferably determined on an individual user, group and overall (all users) level.

In a step S3C, an optimal reward may then be determined from the performance outcomes. In one configuration, the optimal reward may then be determined as a combination of the weighted average compliance with the specific activity/behavior (preferably for each individual user, user groups and all users) and the weighted average compliance for all activities/behaviors (preferably for each individual user, user group and all users). In particular, the optimal reward is preferably determined to be the one or more rewards which predict (based upon past results) the highest rate of future compliance of a user's activities to the goals/achievements. In one embodiment, the optimized rewards may comprise rewards which are optimized by frequency of occurrence and by reward amount or type, which variable may change over time based upon user compliance.

As illustrated in FIG. 2, the reward randomizer 58 may be configured to generate and output a randomized reward. In one embodiment, the reward randomizer 58 may implement or utilize a random number generator or other randomizer in order to randomly select one or more rewards, such as from a set of rewards. The set may include one or more rewards generated by the optimizer 60 and preferably includes at least one option for “no reward.” In one embodiment, a first set of rewards might be stored in association with a user, group or users or otherwise. The set of rewards might be configured in a table format where particular rewards occur in different frequencies and may thus be selected with different frequencies. For example, such a table might be configured to result in the following frequency of selection of the following rewards:

TABLE 1

| Randomized Rewards | Frequency |
|---|---|
| A. No Reward | 80% |
| B. $1 | 10% |
| C. $5 | 7% |
| D. $50 | 2% |
| E. $500 | 1% |

As indicated this might be accomplished via a selection table where the frequency of the each award in the table results in, relative to randomly generated number, a selection of the rewards with the desired frequency.

TABLE 2

| RNG Outcome | Reward |
|---|---|
| 1 | A |
| 2 | B |
| 3 | A |
| 4 | C |
| 5 | A |
| 6 | A |
| . . . | |

In one embodiment, the optimizer 60 may similarly result in the generation of a set of rewards with associated reward frequencies, such as:

TABLE 3

| Optimized Rewards | Frequency |
|---|---|
| A. No Reward | 60% |
| B. $1 | 30% |
| C. $5 | 9% |
| D. $50 | 0.9% |
| E. $500 | 0.1% |

These awards may be generated in a similar table selection format as described above. As noted, in one configuration, the optimizer 60 may determine that the optimized frequency for the rewards, or the value of awards, may differ from the base set of rewards. For example, as shown above, the optimizer 60 may determine that awarding the user the $500 reward with a frequency of 1% causes the user to reduce their compliance level, and as such, may determine that the frequency should be 0.1%, thus causing the user to “chase” that high award. In this regard, the optimizer 60 may (based upon information from the iterating engine 54) change one or more characteristics of one or more rewards (such as the amount or value, type of reward or reward frequency) over time to predict the user's engagement in activities which achieve one or more of the goals.

In one configuration the reward generator 56 uses the inputs from the randomizer 58 and the optimizer 60 to generate a reward. In one embodiment, the reward which is selected or utilized by the reward generator 56 may comprise either a random reward, such as generated by the reward randomizer 58 (which selected award may comprise “no reward”), or an optimized reward, such as selected by the reward optimizer 60 (which again may comprise “no reward”. In one configuration, the selection of the reward system to be used for reward generation can be done through a logical method, such as “choose random reward once every three times, and choose the optimized reward in other instances”, or the selection of the reward can be done through an additional optimization loop, wherein the frequency of random versus optimized reward is determined by the optimal selection from the overall system. For example, it can be seen that for the first 10 rewards, the distribution of random versus optimized reward is 1:2, for rewards 11-20 the distribution is 1:3, and for rewards 21+ the distribution is 1:4. Of course, in other configurations, the optimized reward might be selected more often/frequently than the randomized reward.

In one preferred configuration, one of the randomized rewards and one of the optimized rewards is a “no reward” option. Again, various methodologies may be utilized for selecting the different reward systems may be utilized, including a table format. In the preferred configuration, the awards which are selected are not always optimized, but in some cases are randomly generated. The inclusion of randomized rewards injects variability into the reward system, aiding in keeping the awards volatile and interesting to the user. In this regard, in one configuration, the rewards which are generated by the reward randomizer 58 may be different from those which are generated by the optimizer 60, thus creating a higher level of variability in the rewards that are provided to the use and thus aiding in keeping the user interested in achieving metrics which result in future awards. For example, while the optimizer 60 might generate a highest award of $100, the randomizer 58 might be permitted to select a highest award of $250. The award of this higher amount, such as after the award of many other awards having a value of $100 or less, may entice the user because the user then believes that higher awards may exist in the future. In this regard, the available random rewards might also change over time (and as those rewards change over time, the optimizer 60 may utilize the feedback resulting from those awards to then change the awards which are offered thereby).

The types of rewards that the rewards generator 56 may reward may vary and may comprise messages (such as congratulatory messages or messages of encouragement), points, discounts, physical prizes, money or monetary value, or various other elements of value or perceived value. These rewards may be paid for or sponsored, such as by operators of the activity platforms, employers or groups etc. For example, an employer might set up a rewards program for its employees as users and the employer might pay for the rewards which are awarded to its employees. An activity platform operator might sponsor prizes for users of its platform to maintain the interest of its existing customers and to attract new ones. In one embodiment, one or more rewards may be populated into the database 62 (where the rewards may be associated with particular users, groups, etc., such as noted above).

As noted, the selection of rewards from the one or more reward sets may be optimized over time. For example, a set of rewards might comprise $1, $5, $10, $100 and $100, and over time, the optimizer 60 may determine that the optimal prizes are $5 and $100, thus causing them to be selected more frequently. As another example, the rewards available might comprise a range of rewards from $1-$100, where the optimal reward might comprise a particular reward value or values in $1 increments (e.g., the reward might be a maximum of $100, but the optimal reward might be determined to be $59; it being understood that the randomizer 58 might cause no reward to be selected, which may be equated to a reward of $0).

Referring again to FIG. 3, in a step S4, the rewards platform 22 preferably outputs the reward. Rewards might be awarded in various manners. For example, notification of a reward might be provided to one or more users via messaging (text, email, etc.) or via an application, or physically (delivery of a physical award such as a good, printed coupon, etc.).

In one embodiment, a user might be notified of a reward or provided with a reward via an application running on the user's device 30. Such an application might be downloaded by the user to their device 30 into the memory thereof for execution by the processor thereof. The may be configured to generate one or more graphical user interfaces for displaying information to a user and/or receiving information or input from a user. The graphical user interface might display information regarding activities, past rewards and new rewards, among other things. For example, the rewards platform 22 (such as the server 24) may be configured to cause the application running on the user's device 30 to display a notification regarding a new reward. This notification might include information regarding the basis for the reward (“Congratulations on breaking a 6 minute mile time!”) and information regarding the reward, such as information regarding the particular reward and, when applicable, how to obtain and/or redeem the award.

Of course, the graphical user interface might have other configurations and/or be configured to display other information. For example, the graphical user interface might display a selectable menu, might display user login information or the like.

In a preferred embodiment of the invention, the rewards platform 22 includes a feedback feature. In general, this feature is intended to assess the effectiveness of particular awarded rewards on user behavior and use that information to modify future rewards with a goal of optimizing the awarded rewards to maximize their effectiveness. This is illustrated as step S5 in FIG. 3.

As indicated, in one embodiment, the rewards platform 22 includes an iterating engine 54. The iterating engine 54 may obtain activity information, such as from the tracking engine 50. The iterating engine 54 also obtains information regarding awarded rewards R.

In one embodiment, the iterating engine 54 implements a behavior variability generator 64. This generator 64 examines the activity inputs (of a user, group, etc.) over time in relation to awarded rewards and generates an output which is provided to the optimizer 60 for use in optimizing awarded rewards, as at step S6 of FIG. 3.

As one example, the rewards engine 52 might award a first reward of $10 for a user writing 1000 lines of software code in 1 day, a second reward of $10 for a user writing 1250 lines of software code in 1 day a week later, a third reward of $100 for a user writing 1500 lines of code in 1 day a week later, and then the user might not write 1750 lines of code in 1 day for over a month. This may indicate to the iterating engine 54 that the large award (of $100) caused the user to slow the rate of their progress, as compared to smaller rewards that kept the user chasing the next reward. As a result, the optimizer 60 may utilize this information to modify the awarded reward, such as to lower the amount rewarded to the user for their next achievement.

In one embodiment, as the tracking engine 50 tracks user activity information against user goals, the tracking engine 50 may generate one or more messages to the user, such as regarding their performance in relation to one or more user goals. For example, the tracking engine 50 might determine that the user has run 18 miles in one week, short of a 20 mile goal in a week. The tracking engine 50 might thus notify the user that “you've run 18 miles this week-only 2 miles short of your goal: Run two more miles this week for a chance at a reward!”. Of course, various messages might be generated and transmitted to the user (such as via email, text, an application or the like). Further, the tracking engine 50 might obtain information from the rewards engine 52 regarding one or more potential rewards, such as to provide a message like “you've run 18 miles this week-only 2 miles short of your goal: Run two more miles this week for a chance for a $500 reward!”.

The invention solves problems and address issues which exist with existing reward methods, whether manually implemented or implemented by existing systems. One aspect of the invention is a reward system which may be linked to a variety of existing devices and systems so as to implement rewards relative thereto, without having to modify the existing device or system. For example, the rewards platform of the invention may be linked to an existing exercise tracking platform or device, a work performance platform or device, a shopping purchase system or device or the like, thereby immediately allowing for the implementation of rewards relative thereto.

Another advantage of the system and method of the invention is that one or more rewards are optimized based upon user feedback, namely the user's performance in relation to prior awards. The rewards are optimized, such as by changing the reward type, amount or frequency, in order to optimize the probability of the user's compliance with activity goals.

Another advantage of the system is that volatility is introduced into the rewards process, thus preventing the user from predicting the granting of certain rewards. This volatility may be introduced via the variability generator 64 and/or by the selection of rewards from either an optimized reward or a random reward. The random reward may be entirely different, such as in amount, type or frequency, from the optimized rewards, thus introducing volatility of the rewards to the user. The introduction of such rewards may also reveal that certain rewards result in a change in user compliance with activity goals, and may thus be used by the rewards optimizer to further optimize rewards in a manner that entices user compliance.

These features are preferably implemented by a system which allows for tracking of user activities against goals, generation of rewards and optimization of rewards, in real-time, including across multiple users—including groups of users.

It will be understood that the above described arrangements of apparatus and the method there from are merely illustrative of applications of the principles of this invention and many other embodiments and modifications may be made without departing from the spirit and scope of the invention as defined in the claims.

1. A variable rewards system comprising:
a downloadable application for storage in a memory of a user mobile communication device and execution by a processor thereof to cause said user's mobile communication device to receive input of at least one activity goal;
a rewards platform, said rewards platform comprising at least one server and a data storage device, said server comprising a communication interface, a processor, a memory and machine readable code stored in said memory and executable by said processor to cause said server to:
store, in a database associated with said data storage device, said at least one activity goal of said user, said activity goal comprising activity criteria;
implement a tracking engine, said tracking engine configured to:
receive digital data regarding a user's engagement in at least one user activity from an external device or system over an electronic communications network;
transform the digital data into activity metrics
determine if said activity metrics meet said activity criteria for said at least one activity goal; and
when said activity information meets said activity criteria, output a reward trigger;
implement a random number generator;
implement a reward randomizer which is configured to utilize an output of the random number generator to randomly select and output a randomly generated reward;
implement a predictive reward optimizer which is configured to output an optimized reward, which optimized reward is determined, by comparison of past user activity information stored in said database to an expected activity response for one or more prior rewards awarded to said user, to predict compliance of said user's future engagement in activities with at least one of said activity goals; and
implement a rewards engine, said rewards engine configured to:
select, in response to said reward trigger, either said randomly generated award or said optimized reward, wherein said selection of said randomly generated award has at least one first frequency and said selection of said optimized reward has at least one second frequency; and
transmit, via an electronic communication link with said user's mobile communication device for use by said downloadable application in causing a video display thereof to display an indication of said selected reward to said user.

2. The variable rewards system in accordance with claim 1, wherein said digital data comprises data pertaining to one or more exercises.

3. The variable rewards system in accordance with claim 2, wherein said exercise information is received from an exercise tracking platform and said rewards platform is in communication with said exercise tracking platform.

4. The variable rewards system in accordance with claim 2, wherein said exercise information is received from an exercise tracking application running on said user's mobile communication device.

5. The variable rewards system in accordance with claim 1, wherein said digital data comprises data regarding engagement in one or more work activities.

6. The variable rewards system in accordance with claim 1, wherein said digital data comprises data regarding one or more purchases.

7. (canceled)

8. The variable rewards system in accordance with claim 1, wherein said at least one activity goal comprises a group goal where said user is a member of said group.

9. The variable rewards system in accordance with claim 1, wherein said randomly generated award is randomly selected from a set of rewards.

10. (canceled)

11. The variable rewards system in accordance with claim 1, wherein said randomly generated award is different than said optimized reward.

12. The variable rewards system in accordance with claim 1, wherein said randomly generated award is selected from a first set of rewards and said optimized reward is selected from a second set of rewards which differs from said first set of rewards.

13. The variable rewards system in accordance with claim 1, wherein said randomly generated reward is selected with a first frequency which is higher than said second frequency with which said optimized reward is selected.

14. The variable rewards system in accordance with claim 1, wherein said reward optimizer modifies at least one of a reward type, value and/or frequency based upon changes in said activity information.

15. The variable rewards system in accordance with claim 14, wherein said modification is selected in order to increase a probability that future activity information of said user will meet said activity criteria for at least one activity goal.

16. The variable rewards system in accordance with claim 1, wherein said selected reward comprises a monetary amount.

17. The variable rewards system in accordance with claim 1, wherein said tracking engine is configured to store said activity information of said user.

18. The variable rewards system in accordance with claim 1, wherein said randomly generated award may comprise no reward and said optimized reward may comprise no reward.

19. The variable rewards system in accordance with claim 1, wherein said reward randomizer randomly selects awards from a table of rewards stored in said database.

20. (canceled)
